(19) United States
(12) Patent Application Publication
(10) Pub. No.: US 2021/0360340 A1
(43) Pub. Date: Nov. 18, 2021

(54) WATERPROOF SOUND-TRANSMISSION MEMBRANES

(71) Applicants: Peng-Fei ZHOU, Shanghai (CN); Hewlett-Packard Development Company, L.P., Spring, TX (US)

(72) Inventor: Peng-Fei Zhou, Shanghai (CN)

(21) Appl. No.: 16/479,717

(22) PCT Filed: Jan. 17, 2018
(86) PCT No.: PCT/CN2018/073038

§ 371 Date: Jul. 22, 2019

(51) Int. Cl. H04R 1/02; H04R 7/08

(52) U.S. Cl. CPC H04R 1/023; H04R 2307/025; H04R 7/08; H04R 1/025

(57) ABSTRACT

A speaker comprises a housing having an opening; a waterproof sound-transmission membrane disposed on the housing to cover the opening of the housing; a speaker unit housed in the housing, the speaker unit comprising a speaker having a diaphragm; and an annular polymer membrane disposed between the diaphragm and the waterproof sound-transmission membrane, the annular polymer membrane comprising a through-opening in a radial direction with respect to the annular polymer membrane.

### BACKGROUND

Devices, such as computers, mobile phones, and music devices, may transmit sound for various purposes. Such devices may have a speaker unit and an opening through which sound waves from the speaker unit may be transmitted.

### BRIEF DESCRIPTION OF DRAWINGS

The following detailed description references the drawings, wherein:

FIG. 1 illustrates a device with a waterproof sound-transmission membrane, according to an example;

FIG. 2 illustrates a cross-sectional view of the device of FIG. 1, according to an example;

FIGS. 3(a)-3(c) illustrate examples of a polymer membrane having one through-opening;

FIGS. 4(a)-4(d) illustrate examples of a polymer membrane having more than one through-opening;

FIG. 5 illustrates a device with a waterproof sound-transmission membrane, according to an example;

FIG. 6 illustrates a cross-sectional view of the device of FIG. 5, according to an example; and

FIG. 7 illustrates a cross-sectional view of a device with a waterproof sound-transmission membrane, according to an example.

### DETAILED DESCRIPTION

Audio devices may have a housing that houses a speaker unit. The speaker unit may include a speaker having a diaphragm. An annular polymer membrane, for example made of foam, may be provided between the diaphragm of the speaker unit and the housing to support the attachment of the diaphragm with the housing. The housing may have an opening through which airflow associated with sound waves from the diaphragm of the speaker unit is passed. For making such an audio device waterproof, the opening in the audio device may be covered by a waterproof sound-transmission membrane that allows sound to transmit through but does not let water or any other fluid to pass through. The waterproof sound-transmission membrane of the device generally experiences non-linear vibrations due to the airflow associated with the sound waves from the speaker unit. The non-linear vibrations may distort the sound from the device, which may adversely affect the quality of sound.

The present subject matter describes devices, such as audio devices, with a waterproof sound-transmission membrane. The devices of the present subject matter enable reduction of non-linear vibrations of the waterproof sound-transmission membrane. Reduction of non-linear vibrations of the waterproof sound-transmission membrane facilitates in reducing the distortion of sound and thus improving the quality of sound from the device.

In accordance with an example, a device includes a housing and a speaker unit housed in the housing. The housing may be an enclosure for housing electrical and electronic components. The speaker unit includes a speaker having a diaphragm to generate sound waves. The housing includes an opening through which airflow associated with sound waves, generated from the speaker unit, is passed. The device also includes a waterproof sound-transmission membrane disposed on the housing to cover the opening of the housing to prevent water or any other fluid to pass inside the device. The waterproof sound-transmission membrane may be a mesh-like membrane through which sound waves can pass but water or any other fluid cannot.

In an example, an annular polymer membrane may be disposed between the diaphragm and the waterproof sound-transmission membrane. The annular polymer membrane is a ring-like structure that supports the attachment of the diaphragm with the waterproof sound-transmission membrane or with the housing. The annular polymer membrane used in the device may include a through-opening in a radial direction. The through-opening is an opening from an inner circumferential surface to an outer circumferential surface of the annular polymer membrane. The through-opening in the annular polymer membrane allows a portion of the airflow, associated with the sound waves, to pass therethrough and flow inside the housing. Thus, the net airflow that passes through the waterproof sound-transmission membrane may reduce, which in turn may reduce the magnitude of non-linear vibrations. The portion of airflow passing through the through-opening may attenuate inside the housing. In an example, the annular polymer membrane may include more than one through-opening.

In an example, the waterproof sound-transmission membrane of the device may have a surface area at least two times a surface area of the diaphragm. With such a waterproof sound-transmission membrane, the airflow passing through the waterproof sound-transmission membrane may get distributed over a larger area of the waterproof sound-transmission membrane. Distribution of airflow over a larger area of the waterproof sound-transmission membrane may reduce the magnitude of non-linear vibrations of the waterproof sound-transmission membrane and the distortion of sound from the device.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

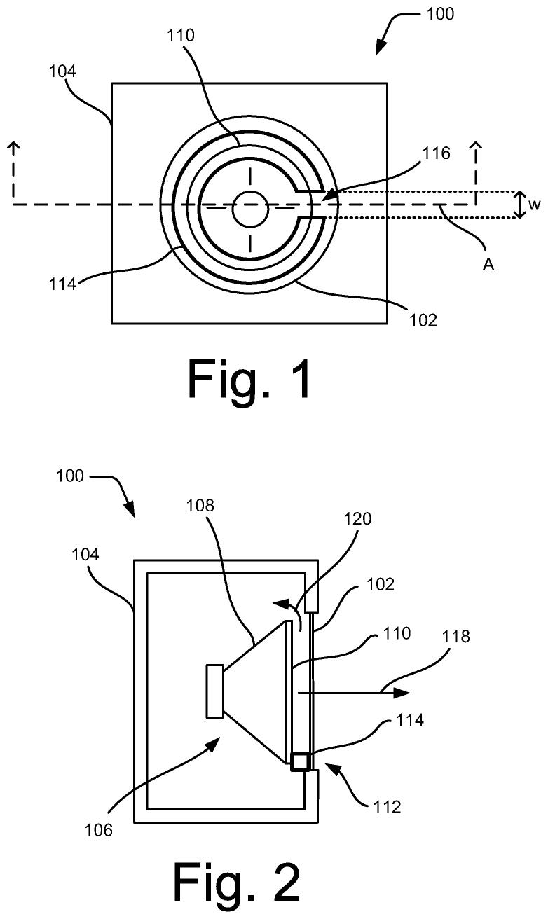

FIG. 1 illustrates a device 100 with a waterproof sound-transmission membrane 102, according to an example. FIG. 2 illustrates a cross-sectional view of the device 100 of FIG. 1 about axis A, according to an example. As shown, the device 100 includes a housing 104 that encloses a speaker unit 106. The speaker unit 106 includes a speaker 108 and a diaphragm 110. The housing 104 has an opening 112 to pass the airflow associated with the sound waves from the speaker unit 106. Although, the opening 112 is shown as a circular opening, the housing 104 may have an opening of any other shape, for example, elliptical, square, and rectangular.

In an example, the housing 104 may enclose other electronic and electrical components (not shown) which may be utilized for operation of the device 100. The device 100 may also include an input/output interface (not shown) for connecting a power cable, data communication cable, or other peripheral devices.

The waterproof sound-transmission membrane 102 is disposed on the housing 104 so as to cover the opening 112. The waterproof sound-transmission membrane 102 may be a mesh-like porous membrane. The waterproof sound-transmission membrane 102 may be made of a polymer material including, but not restricted to, polyethylene, polyamide, and polypropylene. In an example, the waterproof sound-transmission membrane 102 may be coated with a hydrophobic material.

Further, the device 100 includes a polymer membrane 114 disposed between the diaphragm 110 and the waterproof sound-transmission membrane 102. One side of the polymer membrane 114 may be coupled to the diaphragm 110, and another side of the polymer membrane 114 may be coupled to the waterproof sound-transmission membrane 102. The polymer membrane 114 may be coupled using an adhesive. In an example, the polymer membrane 114 may be made of a foamed polymer or a sponge.

The polymer membrane 114 has an annular shape, and thus may also be referred to as the annular polymer membrane. The polymer membrane 114, as shown in FIG. 1, includes a through-opening 116 in a radial direction with respect to the polymer membrane 114. The through-opening 116 is such that it allows a portion of the airflow associated with the sound waves from the speaker unit 106 to pass therethrough. In an example, the through-opening 116 in the polymer membrane 114 may have a width ‘w’ in a range of 10% to 25% of a circumference of the annular polymer membrane. It may be noted that the width of the through-opening 116 refers to the width along the circumference of the polymer membrane 114.

As shown in FIG. 2, a portion of the airflow associated with the sound waves from the speaker unit 106 may flow out in a direction 118 through the waterproof sound-transmission membrane 102. A portion of the airflow associated with the sound waves may flow through the through-opening 116 in a direction 120. As a result, the non-linear vibrations of the waterproof sound-transmission membrane 102 may be reduced. The portion of airflow flowing through the through-opening 116 may attenuate inside the housing 104.

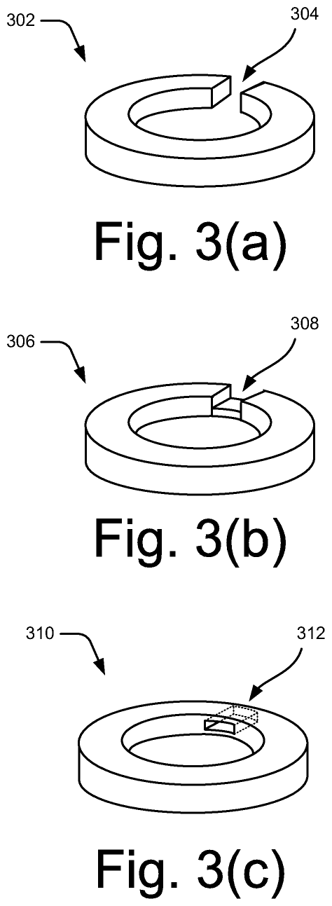

FIGS. 3(a)-3(c) illustrate examples of a polymer membrane having one through-opening. The polymer membranes shown in FIGS. 3(a)-3(c) are annular in shape. The through-opening is from an inner circumferential surface to an outer circumferential surface of the annular polymer membrane. In an example, the through-opening may be throughout the thickness of the polymer membrane in a direction perpendicular to the plane of the polymer membrane. In an example, the through-opening may encompass a portion of the thickness of the polymer membrane in a direction perpendicular to the plane of the polymer membrane.

The polymer membrane 302, as shown in FIG. 3(a), has a through-opening 304 throughout the thickness of the polymer membrane 302 in a direction perpendicular to the plane of the polymer membrane 302. The polymer membrane 302 thus is in the form of a partial annular structure. The partial annular structure is an annular structure with a discontinuity. The partial annular structure may be equal to 60% to 90% of a full annular structure.

The polymer membrane 306, as shown in FIG. 3(b), has a through-opening 308 in a portion of the thickness of the polymer membrane 306 in a direction perpendicular to the plane of the polymer membrane 306. The polymer membrane 310, as shown in FIG. 3(c), also has a through-opening 312 in a portion of the thickness of the polymer membrane 310 in a direction perpendicular to the plane of the polymer membrane 310. The dimension of the through-opening 308, 312 along the thickness of the polymer membrane may be 30% to 70% of the thickness of the polymer membrane. Further, the through-opening 308, 312 may have a width in a range of 10% to 25% of a circumference of the annular polymer membrane.

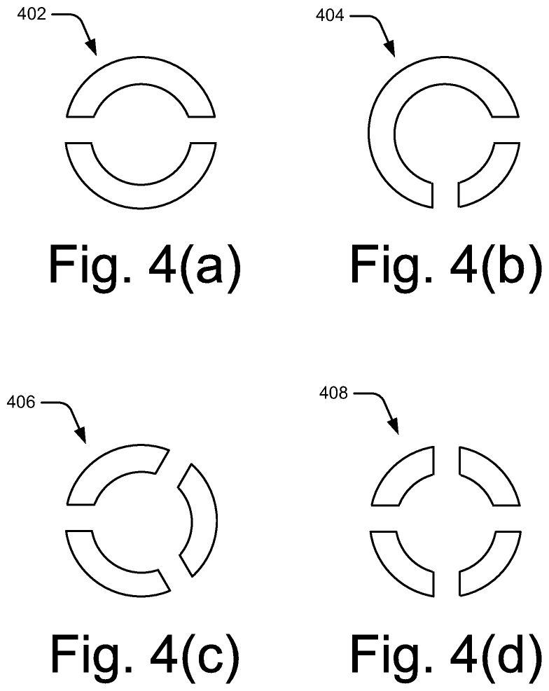

Further, the polymer membrane used in the device 100 may include more than one through-opening. Some examples of a polymer membrane having more than one through-opening are shown in FIGS. 4(a)-4(d). The polymer membranes shown in FIGS. 4(a)-4(d) are annular in shape. The polymer membrane 402, as shown in FIG. 4(a), includes two through-openings, circumferentially separated by 180°. The polymer membrane 404, as shown in FIG. 4(b), includes two through-openings, circumferentially separated by 90°. The polymer membrane 406, as shown in FIG. 4(c), includes three through-openings, circumferentially separated by 120°. Further, the polymer membrane 408, as shown in FIG. 4(d), includes four through-openings, circumferentially separated by 90°. In an example, each of the through-openings in the polymer membrane 402, 404, 406, 408 may have a width ‘w’ in a range of 10% to 15% of a circumference of the annular polymer membrane.

The polymer membrane is not restricted to as shown in FIGS. 3(a)-3(c) and FIGS. 4(a)-4(d). In an example, the polymer membrane 114 may be elliptical, rectangular, square, and so on. The shape of the polymer membrane may conform to the shape of the opening 112 in the housing 104 of the device 100. In an example, the polymer membrane may include any number of through-openings, symmetrically or asymmetrically present along the circumference of the polymer membrane. Further, the through-openings may be throughout the thickness of the polymer membrane in a direction perpendicular to the plane of the polymer membrane, or in a portion of the thickness in a direction perpendicular to the plane of the polymer membrane.

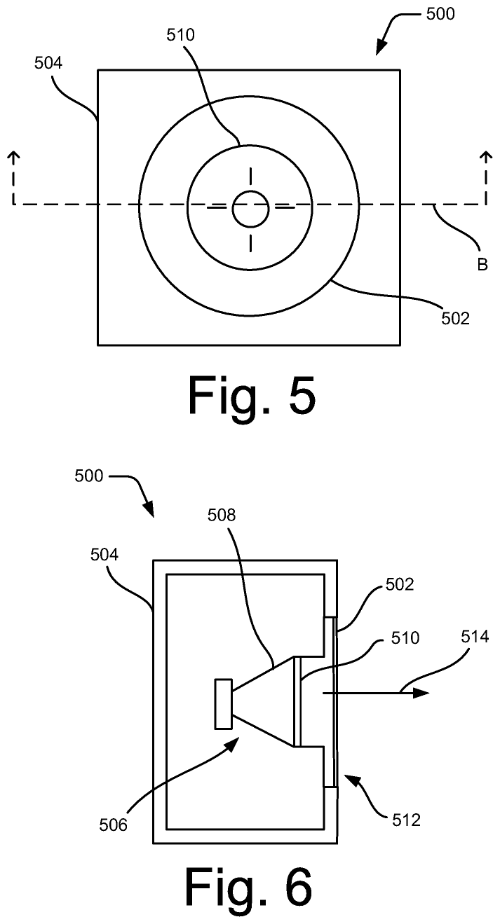

FIG. 5 illustrates a device 500 with a waterproof sound-transmission membrane 502, according to an example. FIG. 6 illustrates a cross-sectional view of the device 500 of FIG. 5 about axis B, according to an example. As shown, the device 500 includes a housing 504 that encloses a speaker unit 506. The speaker unit 506 includes a speaker 508 and a diaphragm 510. The housing 504 has an opening 512 to pass the airflow associated with the sound waves from the speaker unit 506. Although, the opening 512 is shown as a circular opening, the housing 504 may have an opening of any other shape, for example, elliptical, square, and rectangular. In an example, the housing 504 may enclose other electronic and electrical components (not shown) which may be utilized for operation of the device 500. The device 500 may also include an input/output interface (not shown) for connecting a power cable, data communication cable, or other peripheral devices.

The waterproof sound-transmission membrane 502 is disposed on the housing 504 so as to cover the opening 512. The waterproof sound-transmission membrane 502 may be the same as the waterproof sound-transmission membrane 102 described with reference to FIGS. 1 and 2. The waterproof sound-transmission membrane 502 of the device 500 may have a surface area at least two times a surface area of the diaphragm 510 of the speaker unit 506. The surface area of the waterproof sound-transmission membrane 502 may bigger than the surface area of the diaphragm 510 depending on the size of the speaker unit 506 and the size of the device 500. In an example, the surface area of the waterproof sound-transmission membrane 502 may be two times, three times, or four times, the surface area of the diaphragm 510.

With the waterproof sound-transmission membrane 502 bigger than the diaphragm 510, the airflow associated with the sound waves from the speaker unit 506 may flow out in a direction 514 through a larger area of the waterproof sound-transmission membrane 502. The density of airflow flowing through the waterproof sound-transmission membrane 502 may be lesser in comparison to the case when the waterproof sound-transmission membrane of a surface area same as that of the diaphragm is used. As a result, the non-linear vibrations of the waterproof sound-transmission membrane 502 are reduced.

In an example, the device 500 may include a polymer membrane (not shown in FIGS. 5 and 6) disposed between the diaphragm 510 and the waterproof sound-transmission membrane 502. One side of the polymer membrane may be coupled to the diaphragm 510, and another side of the polymer membrane may be coupled to the waterproof sound-transmission membrane 502 or to the housing 504. In an example, the polymer membrane in the device 500 may have a full annular structure, or may have a structure as shown and described with reference to FIGS. 3(a)-3(c) and FIGS. 4(a)-4(d).

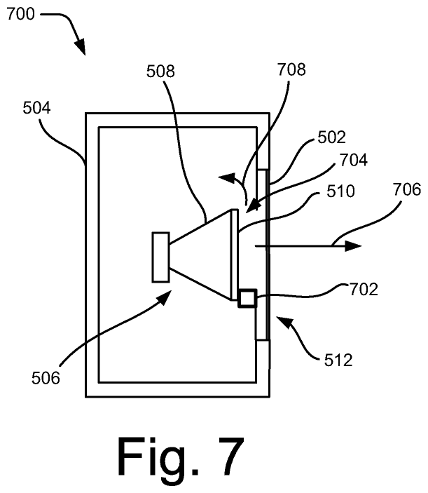

FIG. 7 illustrates a cross-sectional view of a device 700 with a waterproof sound-transmission membrane 502, according to an example. The device 700 may include components of the device 500 as shown in FIGS. 5 and 6. The device 700 additionally includes an annular polymer membrane 702 disposed between the diaphragm 510 and the waterproof sound-transmission membrane 502. One side of the annular polymer membrane 702 may be coupled to the diaphragm 510, and another side of the annular polymer membrane 702 may be coupled to the housing 504. The annular polymer membrane 702 may be coupled using an adhesive. In an example, the annular polymer membrane 702 may be made of a foamed polymer or a sponge.

As described for FIG. 5, the waterproof sound-transmission membrane 502 of the device 700 has a surface area at least two times a surface area of the diaphragm 510 of the speaker unit 506. Further, the annular polymer membrane 702 includes a through-opening 704 in a radial direction with respect to the annular polymer membrane 702, similar to that as shown and described with reference to FIGS. 3(a)-3(c) and FIGS. 4(a)-4(d). In an example, the annular polymer membrane 702 may be a partial annular structure, which may be equal to 60% to 90% of a full annular structure. In an example, the through-opening 704 in the annular polymer membrane 702 may have a width in a range of 10% to 25% of a circumference of the annular polymer membrane 702.

With the waterproof sound-transmission membrane 502 of a surface area of at least twice of that of the diaphragm 510 and the annular polymer membrane 702 with a through-opening 704, the airflow associated with the sound waves from the speaker unit 506 may flow out in a direction 706 through a larger area of the waterproof sound-transmission membrane 502 and may also flow through the through-opening 704 in a direction 708. The magnitude of the non-linear vibrations of the waterproof sound-transmission membrane 702 in device 700 are lesser in comparison to the non-linear vibrations of the waterproof sound-transmission membrane 102 in device 100 and the non-linear vibrations of the non-linear vibrations of the waterproof sound-transmission membrane 502 in device 500.

Although examples for the present disclosure have been described in language specific to structural features, it is to be understood that the appended claims are not limited to the specific features described herein. Rather, the specific features are disclosed and explained as examples of the present disclosure.

We claim:

1. A device comprising:
a housing having an opening;
a waterproof sound-transmission membrane disposed on the housing to cover the opening of the housing;
a speaker unit housed in the housing, the speaker unit comprising a speaker having a diaphragm; and
an annular polymer membrane disposed between the diaphragm and the waterproof sound-transmission membrane, the annular polymer membrane comprising a through-opening in a radial direction with respect to the annular polymer membrane.

2. The device as claimed in claim 1, wherein the through-opening has a width in a range of 10% to 25% of a circumference of the annular polymer membrane.

3. The device as claimed in claim 1, wherein the waterproof sound-transmission membrane has a surface area at least two times a surface area of the diaphragm.

4. The device as claimed in claim 1, wherein the annular polymer membrane is made of a foamed polymer.

5. The device as claimed in claim 1, wherein the annular polymer membrane is made of sponge.

6. A device comprising:
a housing having an opening;
a waterproof sound-transmission membrane disposed on the housing to cover the opening of the housing;
a speaker unit housed in the housing, the speaker unit comprising a speaker having a diaphragm; and
a polymer membrane disposed between the diaphragm and the waterproof sound-transmission membrane, the polymer membrane being a partial annular structure.

7. The device as claimed in claim 6, wherein the partial annular structure is 60% to 90% of a full annular structure.

8. The device as claimed in claim 6, wherein the waterproof sound-transmission membrane has a surface area at least two times a surface area of the diaphragm.

9. The device as claimed in claim 6, wherein the polymer membrane is made of a foamed polymer.

10. The device as claimed in claim 6, wherein the polymer membrane is made of sponge.

11. A device comprising:
a housing having an opening;
a speaker unit housed in the housing, the speaker unit comprising a speaker having a diaphragm; and
a waterproof sound-transmission membrane disposed on the housing to cover the opening of the housing, the waterproof sound-transmission membrane having a surface area at least two times a surface area of the diaphragm.

12. The device as claimed in claim 11, further comprising an annular polymer membrane disposed between the diaphragm and the waterproof sound-transmission membrane, wherein the annular polymer membrane comprises a through-opening in a radial direction with respect to the annular polymer membrane.

13. The device as claimed in claim 12, wherein the one through-opening has a width in a range of 10% to 25% of a circumference of the annular polymer membrane.

14. The device as claimed in claim 12, wherein the annular polymer membrane is made of a foamed polymer.

15. The device as claimed in claim 12, wherein the annular polymer membrane is made of sponge.
